(19) United States
(12) Patent Application Publication
(10) Pub. No.: US 2011/0238492 A1
(43) Pub. Date: Sep. 29, 2011

(54) MAXIMIZING THE RETURN ON INVESTMENT OF LOCAL BUSINESS AD SPEND ON SEARCH ENGINE ADVERTISING USING MULTIVARIATE ANALYSIS

(76) Inventor: Scott Newnam, Morrisville, NC (US)

(21) Appl. No.: 12/748,373

(22) Filed: Mar. 26, 2010

(51) Int. Cl. G06Q 30/00; G06Q 10/00; G06F 17/30

(52) U.S. Cl. 705/14.43; 705/14.46; 707/758; 707/E17.108

(57) ABSTRACT

Local businesses using on line search advertising to attract customers have a difficult time determining the effectiveness of various search terms or how much to bid for each term or search phrase. Local businesses typically fall into a national category. This national category has words and terms related to it which consumers and businesses use to search for providers and information within the category. Multivariate analysis can be used across target words and terms, negative words and terms, product profit margin, product sales volume, customer value, and click thru success to determine an index value for each search term. This analysis can be used to determine the best potential ad budget for a paid search campaign and the best phrases to deploy and optimal bid rates.

### FIELD OF THE INVENTION

This disclosure relates to the field of on line paid search advertising and more particularly to a methodology for paid search ad agencies servicing local businesses to determine which of the possible thousands of paid search terms and words provide the best ad spend return for the business they are servicing and the appropriate amount of ad spend to capture the particular local market they are servicing.

### BACKGROUND

Online search powered by Web-based search engines has proven to be one of the most common methods used by consumers and businesses to find and purchase both products and services. Online search providers such as Google, Bing, and Yahoo! now have the ability for a local business to purchase search based ad content that only pertains to the local businesses geographic location.

The economy is made up of millions of local businesses who are potential purchasers of local search based ad content. These local businesses have established web sites to promote the products and/or services they provide to the local community. Online paid search advertising is on a path to quickly surpass previous forms of advertising local businesses used to reach potential clients such as phone book advertising. The online search providers have employed a system to sell their search based advertising which at first seems quite simple for a local business to deploy and purchase. However, local businesses do not typically have the ability to analyze all of the thousands of possible search terms and phrases to develop an effective local paid search ad campaign. Difficulties include determining how to establish a correct budget for the desired results, how to analyze changing local paid search trends, and how to determine which terms and words actually provide a return on their advertising investment. However on a national level, these local businesses typically fall into a certain category. Local businesses all across the country in this category share common terms and phrases related to their specific business. Local businesses also share several types of customer groups who represent different levels of profit and ongoing profit potential for the local business. Online search providers provide back to the paid advertiser a great deal of data. Never before in the history of advertising has there been such a large amount of raw data available to the individual business related to their paid search advertising campaign. This data comes from both the analytic tools the local business may place on their website and the providers of paid search advertising. However the ability to properly analyze this data is beyond the reach of the local business owner. Local business owners typically make a guess on several things including key search terms, negative search terms, and ad budget. Local business owners do not have a method to take the data fed back to them from the results of their self run campaign to properly analyze the results. A need exists to provide local business owners with a mathematical strategy to develop a paid local search based advertising campaign.

### SUMMARY

In one aspect, a method and system disclosed herein includes gathering data pertaining to a national category of business and in addition data received from on line search providers, calculating the value of at least in part on terms, words, phrases to the local business owner to develop a target budget and key word campaign for a local paid search campaign across any number of online search ad providers.

A local business owner wishing to embark on a paid search advertising campaign has one of two choices: i) attempt to design and run the campaign themselves or ii) pay an outside agency to run the campaign. The local business owner may know his field better than an outside agency. An outside agency may have a better understanding of paid search advertising due to trial and error experience.

A method to categorize the local business owner into a national vertical segment will reveal words, terms, and phrases consumers and businesses use to seek out providers of this vertical segment. High value target terms, words and phrases will be established through methods including data analysis and interviews with other local business owners at a national level in the same vertical segment. For example a potential local customer searching for the term Lexus is quite valuable to the local business selling the Lexus brand, but has very little value to the local business selling appliances. However for the local business selling a competing brand such as BMW, the Lexus search term would have a high value. Furthermore, a local business engaged in repair of the Lexus brand would consider the search term “Lexus repair” to have a very high long term value in capturing a potential repeat customer.

Certain categories of products sold by local businesses have a higher profit margin than other products sold by the same local business. These categories of products have words, terms, and phrases associated with them. For example, a local audio/video business may engage in selling expensive high profit home theater systems and also engage in selling low margin, low priced televisions. A search term such as “best home theater system” has a higher value to the local audio/video business than the search term of “televisions”. Furthermore, the search term of “cheap televisions” may have no value at all to the local audio/video business and a negative term may be employed in the paid search terms to prevent any type of ad for their business being presented to a customer searching for “cheap televisions.”

Furthermore, some search words, terms, or phrases may be very specific to the local business in a category, yet are not widely searched terms. An example of this may be a search term such as “best Maserati dealer in Utah”. This combination of search terms may have a very low cost to allow the ad to be displayed across paid search providers, but this potential client would have a high value to the Maserati dealer in Utah.

All of the potential paid search words, terms, and phrases, including negative phrases which prevent an ad from showing can be captured in a relational database that links to the specific national business category the local business exists within. A weighted index number can then be assigned to each potential word, term, or phrase used in a paid search ad based upon the national category the local business falls within.

Data from the providers of paid search advertising such as Google, Bing, Yahoo!, and others will reveal the estimated market price for high positioning of paid search ads based upon the various geographic locations. High positioning of paid search ads is desired by the local business to present their ad to potential clients searching for providers of their product or service. Furthermore data from the paid search providers will reveal the inventory of search ads available in a specific local geographic area. Both of these data sets are changing every minute and can be constantly updated with real time information.

Data from the providers of paid search advertising such as Google, Bing, Yahoo!, and others is available in real time to measure the effectiveness of both paid search words, terms, and phrases and the positioning of these words, terms, and phrases based both on the local ad being shown to the local potential customer and the rate of clicks to the promoting website of the local business by the potential local customer.

Multivariate analysis can be used across a set of relational data bases to establish the target budget for the local business falling into a national category, based upon their geographic location, and the national category. On going updates to the data bases, from the providers of the local paid search ads can be fed back into the data bases as related to providing enough ad spend for the ad to be shown, positioning of ads, and click through rates of the ad to the local businesses web site. This analysis can then adjust the ad spend budget and words, terms, phrases and keyword bid rates based on real time local data that relates to the local business. Data trends can be found on a national level as they relate to search words, terms, and phrases as the market within the national category may evolve.

### BRIEF DESCRIPTION OF THE FIGURES

The invention and the following detailed description may be understood by reference to the following figures:

FIG. 1 illustrates a generalized method to establish a vertical master list.

FIG. 2 illustrates a method to establish a set of negative terms for a vertical master list.

FIG. 3 illustrates a generalized method to develop a connected set of key words, terms, and phrases with related negative key words, terms, and phrases (word groupings).

FIG. 4 illustrates a generalized method to place a value in several categories on each word grouping.

FIG. 5 illustrates a mathematical method to derive an index value for each word grouping.

FIG. 6 illustrates a method to project a local cost for a preferred ad position for each word grouping.

FIG. 7 illustrates a generalized method to add local specific word groupings and use a mathematical method to obtain an index factor for the local specific word groupings.

FIG. 8 illustrates a mathematical method to derive a total suggested budget for a local individual business search based ad campaign.

FIG. 9 illustrates a generalized process to obtain an actual budget from an individual local business and from there to use a mathematical method to derive a target word grouping and target bid price for each word grouping.

FIG. 10 illustrates a method to analyze real time results of the individual local business ad campaign and feed these results into a mathematical method to obtain a local index score for word groupings, which through a mathematical method derives a revised target word grouping and revised target paid search campaign budget.

### DETAILED DESCRIPTION

The methods and systems disclosed herein relate to the domain of paid local on line search campaigns for local businesses.

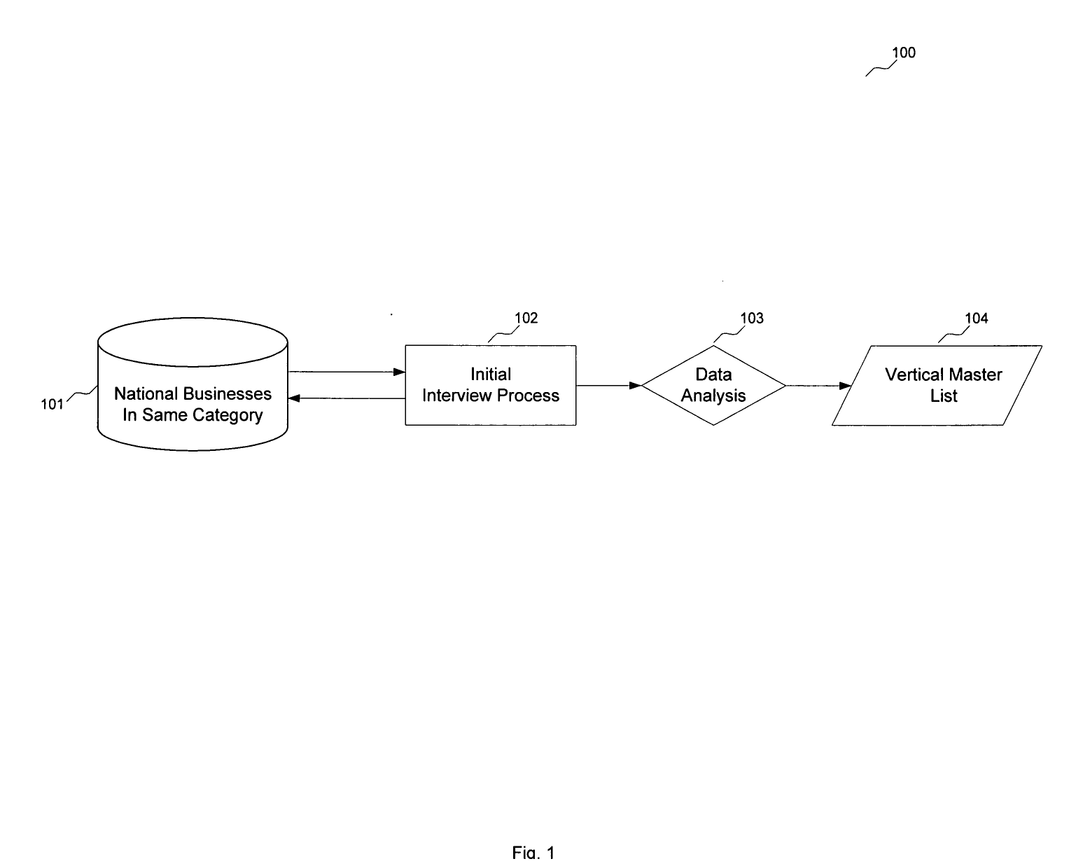

FIG. 1 represents a method 100 to derive a list of terms and phrases 104 that relate to a specific category of business 101. The method 100 is a manual interview process 102 with person or persons having detailed knowledge of the specific category of business 101. The specific category of business 101 may be any type of business where there may be other businesses in this same category across a large geographic region. The interview process 102 generates a list of terms and phrases which are refined by a data analysis method 103 to construct a vertical master list 104 of terms and phrases related to a specific national business category 101. The method 100 may be applied to any category of business. In embodiments, the vertical master will be all terms and phrases that could be used in a search that could be associated with products and services related to the specific category of business. Terms and phrases that could possibly not be related to the specific business will be removed through the data analysis method.

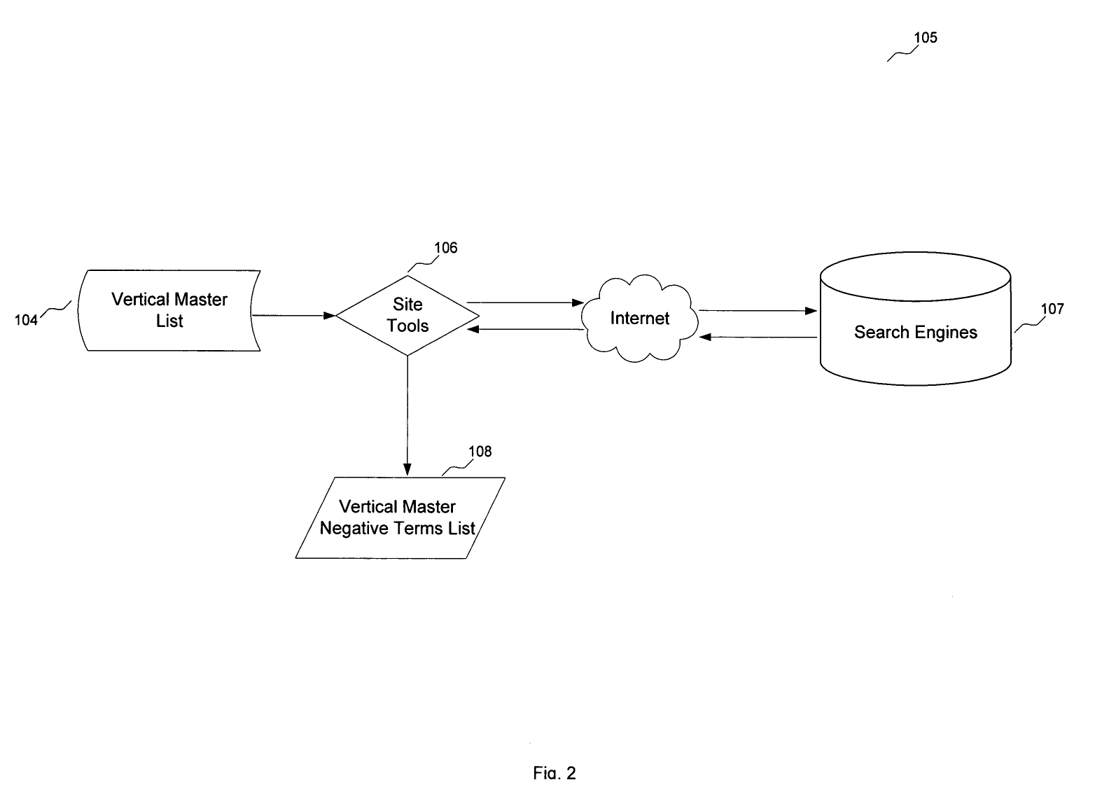

FIG. 2 represents a method 109 to derive a list of negative terms and phrases 105. A term or phrase found in the vertical master list 104 when input into a search engine in combination with a term or phrase not found in the vertical master list 104 may result in an undesirable search result. The search engines 107 such as Google, Bing, Yahoo!, and others provide a set of tools 106 used to determine other terms and phrases related to a searched term or phrase 104. These other terms and phrases may have a negative impact on the desired outcome of a paid search within a local business paid search campaign 147. These undesired other terms and phrases are input into the vertical master negative terms list 108. In embodiments, the negative terms and phrases may be obtained by a manual method of entering each of the terms and phrases in the vertical master list 104 and comparing them to the existing terms and phrases in the vertical master list or an automated data query method of the search engines.

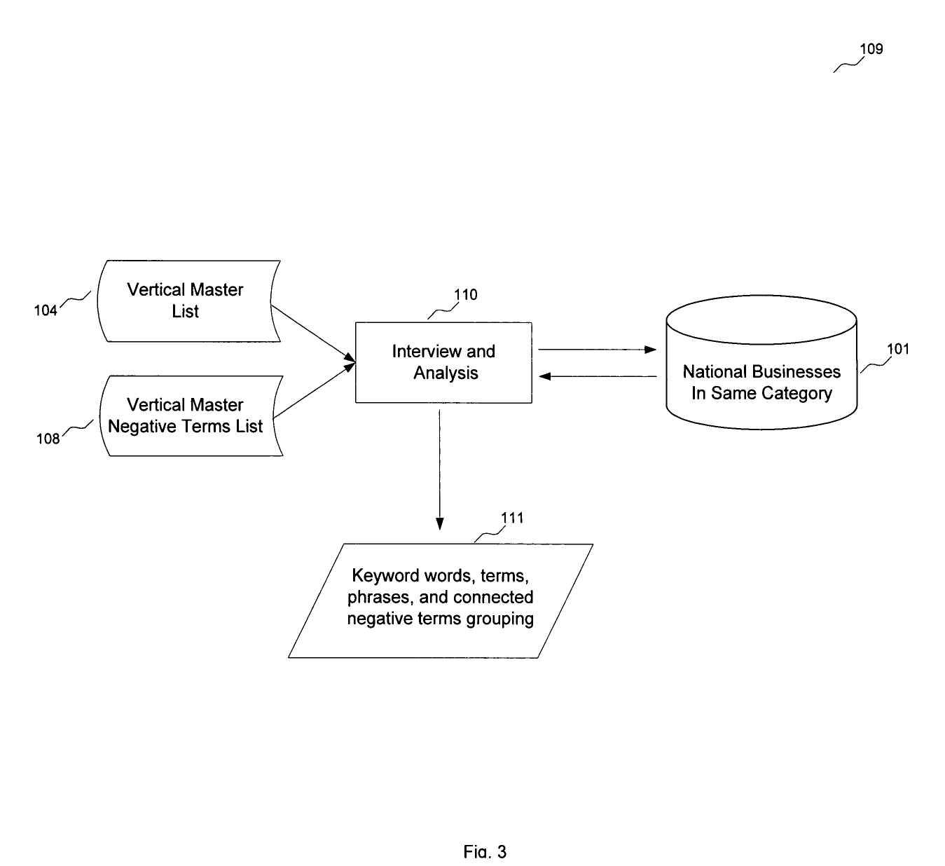

FIG. 3 represents a method 109 to derive a list of keyword terms and phrases in addition to a list of relevant negative terms and phrases 111. The method 109 is a manual interview process 110 with person or persons having detailed knowledge of the specific category of business 101. The interview and analysis method 110 will confirm or deny with person or persons having detailed knowledge of the specific business category 101 that the negative terms and phrases 108 derived with search engine 107 tools 106 are an accurate data set. The interview and analysis 110 generates a list of keyword terms and phrases in addition to a list of relevant negative terms and phrases 111. In embodiments, this method 109 involves comparing with the specific industry expert or experts every related term or phrase derived from the method in FIG. 2 that could be a possible negative term of phrase. A negative term or phrase when entered into a search engine with a desired term or phrase could yield a search result not relevant to the specific business category. In embodiments, the negative terms and phrases will be used in conjunction with the desired terms and phrases in an ad campaign for individual businesses in the specific national business category. These negative terms and phrases will prevent on line ads from being displayed if the negative term or phrase was entered by the party entering data into a search engine.

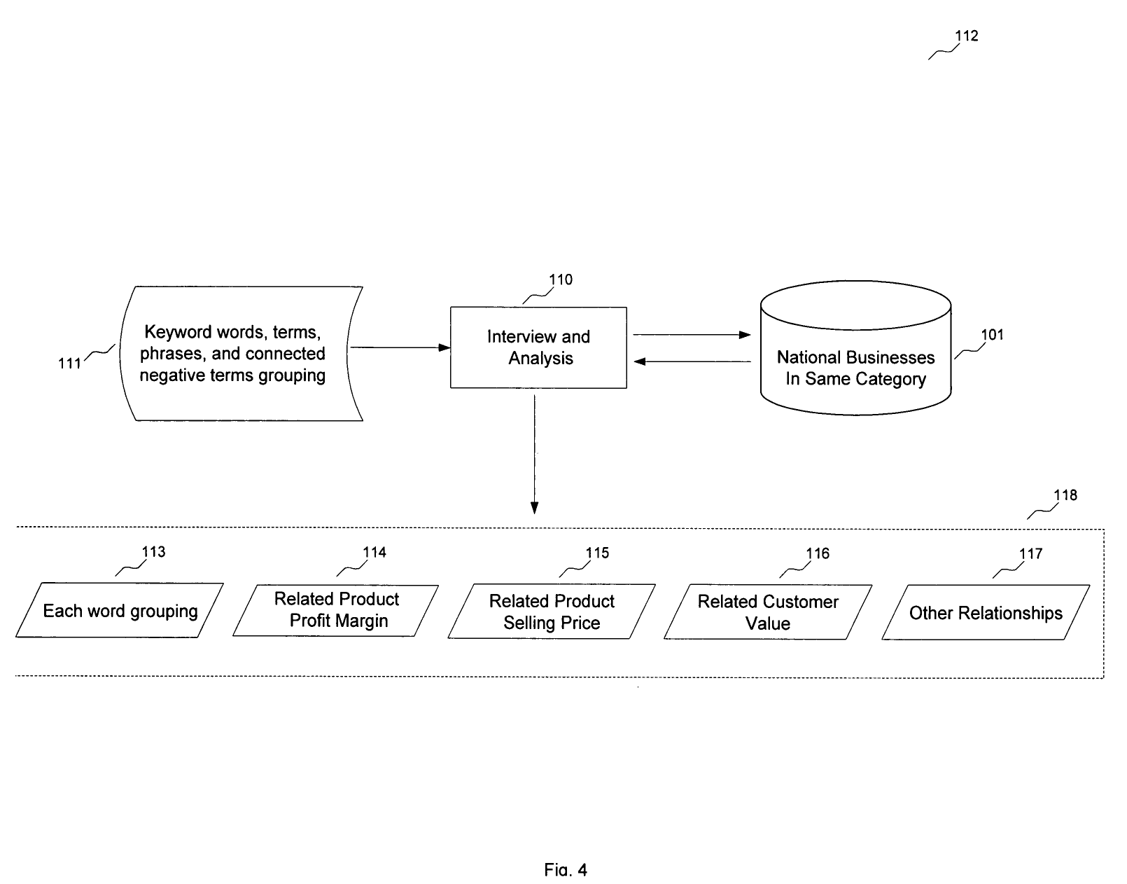

FIG. 4 represents a method 112 to add related data to the keyword terms and phrases 111. A relational database 118 is built which links each individual term or phrase 113 to factors that influence the value of the individual term or phrase 113. The interview and analysis process 110 includes several questions about each individual term or phrase 113. The answers to these questions are typically obvious to someone with experience in the individual business category. Related product margin 114 refers to the profit percent typical of products or services shown when an on line search is done for that individual word or term 113. Related selling price 115 refers to the total dollar selling price typical of products or services shown when an on line search is done for that individual word or term 113. Related customer value 116 refers to a scale of long term potential value of a person or persons typically searching for the individual word or term 113. Other relationships 117 may exist for the individual search word or term and may include but not be limited to relevant industry news about the individual search word or term 113, reputation of any products or services linked to the individual search term or phrase 113, and data search trends of the individual search word or term 113. The method 112 results in a large database of information linked to each individual search word or term. An example of one row of the database 118 is shown in FIG. 4. All fields in the database 118 with the exception of the individual word or term 113 are assigned a statistical value. In embodiments, the related profit margin, related selling price, related customer value, and other attributes are used to assign values to each of the search terms and phrases. In embodiments, these values may vary from one specific national business to another. In embodiments, these values are assigned through a series of interviews with experts or experts related to the specific national business category.

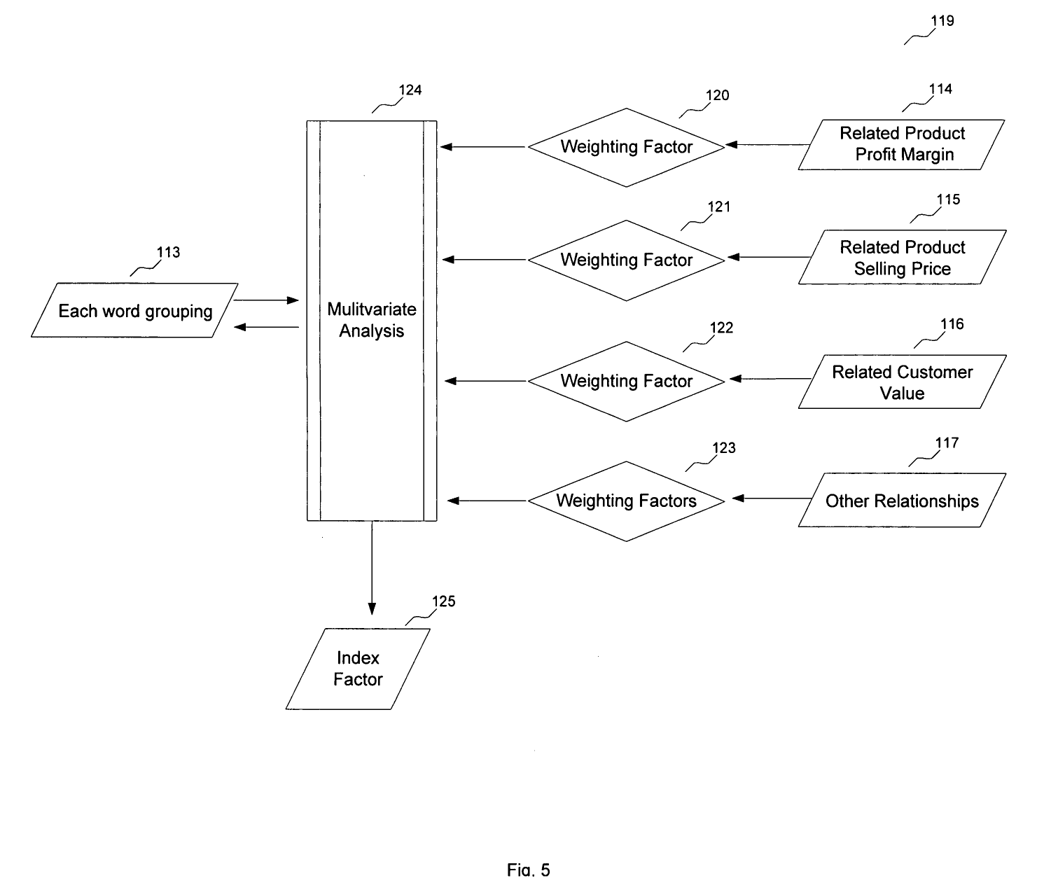

FIG. 5 represents a mathematical method 119 using multivariate analysis to derive an index factor 125 for each individual search term or phrase 113. The weighting factor 120 for related profit margin 114 is assigned the same statistical value across the database for the individual national business in the same category FIG. 1 101. The weighting factor 121 for related selling price 115 is assigned the same statistical value across the database for the individual national business in the same category FIG. 1 101. The weighting factor 122 for related customer value 116 is assigned the same statistical value across the database for the individual national business in the same category FIG. 1 101. The other weighting factors 123 for other related values 117 are each assigned the same statistical value across the database for the individual national business in the same category FIG. 4 101. The statistical values assigned to each weighting factor will vary from individual national business FIG. 4 101. to another. Using multivariate analysis 124, an index factor 125 is calculated for each individual search term or phrase in the relational database FIG. 4 118 for the individual category of business FIG. 4 101. In embodiments, this statistical method weighs the various characteristics of the search terms and phrases to derive a true value of the search term or phrase as it relates to other possible search terms and phrases of the same specific national business category.

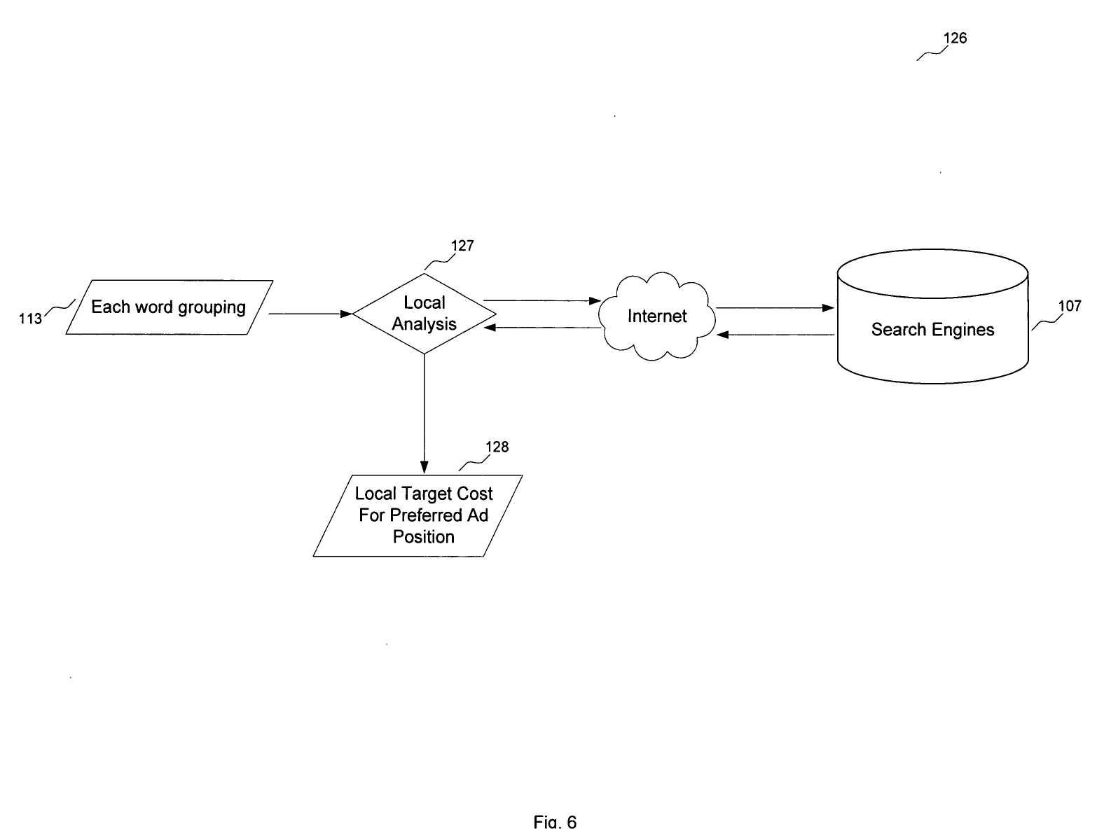

FIG. 6 represents a method 126 to project a local target cost for preferred ad position 128 for each individual search term or phrase in a specific geographic area. Bid rates for the same individual search term or phrase vary widely across geographic regions. Using the local analysis tools 127 provided by the national search engines 107, a projected cost for preferred ad position 128 can be derived for each individual search term or phrase 113. The projected cost for preferred ad position 128 for each individual search term or phrase 113 populates a field in the relational database FIG. 4 118. In embodiments, a manual or automated tool may be used to enter each of the various search terms and phrases along with the related negative terms and phrases into the advertising tools provided by national search engines to derive the estimated local cost, specific to each geographic region, of having the national search engines display an ad related to these search terms and phrases in a preferred position.

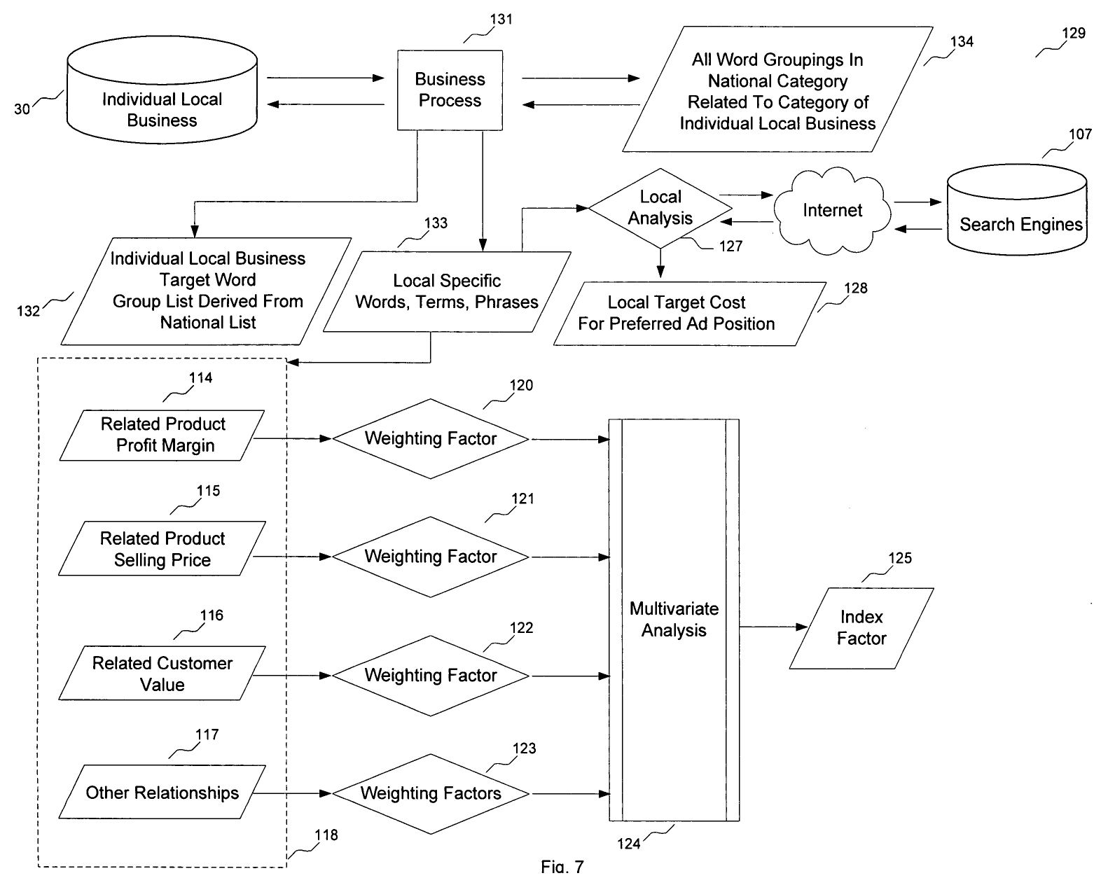

FIG. 7 represents a method to derive a specific list of search terms and phrases for an individual business from the national specific business category the individual local business falls within and to add local specific search terms 133 or phrases to a database for each individual local business 130 and to derive using multivariate analysis 124 an index factor 125 for each of the local individual business specific search terms and phrases 133 and to derive a projected target cost for preferred placement for each of the individual local business terms and phrases. Using a business process 131, each individual local business 130 is interviewed. All of the national search terms and phrases 134 are discussed with the individual local business. Not all of these national terms and phrases will be relevant to the individual local business 130 due to many factors including product line differences within the same category and or the fact the individual local business may not specialize in all areas of this specific national business. The business process 131 will eliminate for the specific individual local business 130 any of the national terms and phrases 134 that are not relevant to the individual local business 130. This data set becomes the individual local business target word list 132. During the business process 131 certain local specific search words and phrases 133 may be derived. These local specific terms and phrases 133 may be geographic terms and phrases, local slang or colloquialisms, terms and phrases related to unique products or services the individual local business provides, or any other terms and phrases uniquely linked to the individual local business. This data set of unique local terms and phrases 133 is processed with the same method used in FIG. 4 112 to add related data to terms and phrases related to the individual local business. Using the same mathematical method shown in FIG. 5 119, a weighting factor is assigned to each of the related terms including profit margin 114, selling price 115, customer value 116, and other relationships 117. Using multivariate analysis 124 an index factor 125 is assigned to each individual term or phrase in the local individual business specific terms and phrase database 133. Using the same method represented in FIG. 6 126, each of the local individual business specific terms and phrases 133 is assigned a projected cost for preferred ad position 128. In embodiments, this method is used to possibly reduce the size of the list of all terms and phrases for a specific national industry to only those terms and phrases that relate to the products and or services provided by the specific local business. In embodiments, the interview method is used to derive any other terms and phrases that may relate specifically to the individual business. In embodiments, this statistical method weighs the various characteristics of the specific search terms and phrases related to the individual business to derive a true value of the search term or phrase as it relates to other possible search terms and phrases of the same specific national business category. In embodiments, a manual or automated tool may be used to enter each of the local specific to the individual business search terms and phrases along with the related negative terms and phrases into the advertising tools provided by national search engines to derive the estimated local cost, specific to the geographic region of the local business, of having the national search engines display an ad related to these search terms and phrases in a preferred position.

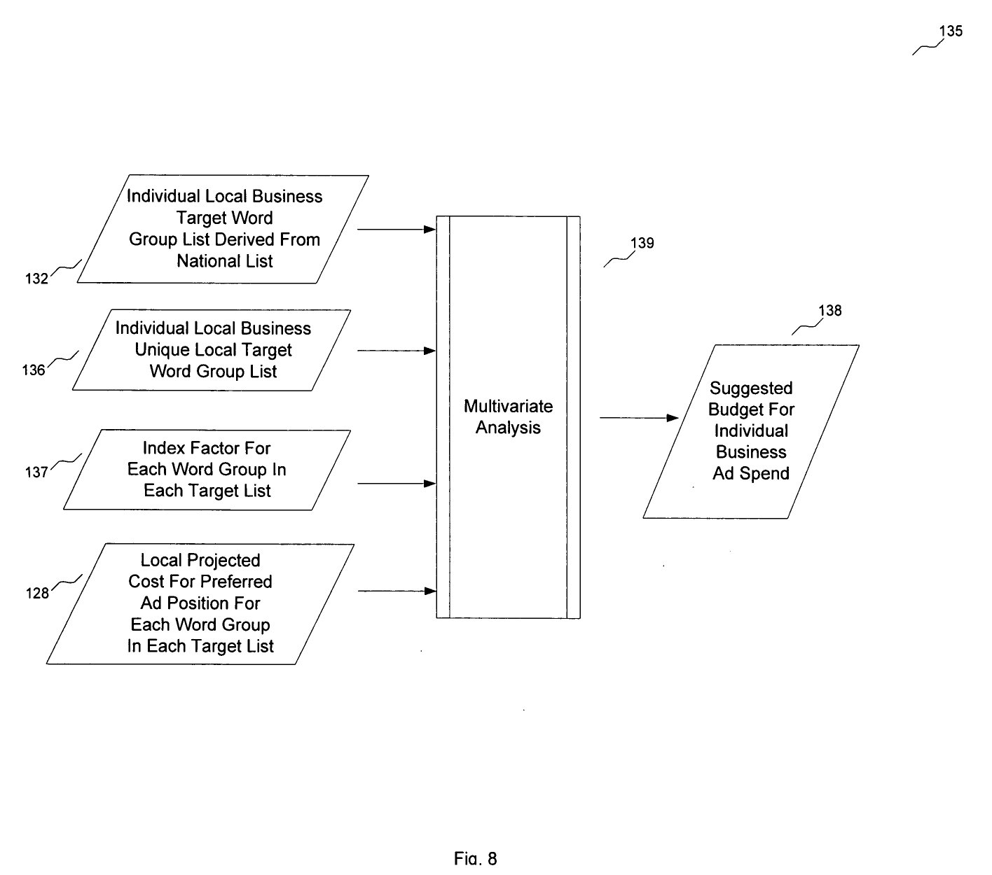

FIG. 8 represents a method 135 to derive a suggested advertising budget for paid local search 138 using multivariate analysis 139 for a specific individual local business FIG. 7 130. The method applies multivariate analysis 139 to the refined national terms and phrase list 132, the individual local business specific terms and phrase list 136, the index factor 137 derived by the method represented in FIG. 5 119, and the projected target cost for preferred ad position 128 for each of the terms and words in both the refined national terms and phrase target list 132 and the individual local business specific terms and phrase list 136. The analysis produces a suggested ad spend budget 138 for the individual local business. In embodiments, this is a method to derive, an estimated search engine advertising ad budget for a specific local business. In embodiments, the terms and phrases from the national list that relate to the specific local business, the terms and phrases that relate only to the specific local business, the estimated cost of displaying these search terms in preferred position, and the relative importance of each of these terms and phrases are all entered into a multivariate analysis tool to derive the total estimated advertising budget needed for the specific local business.

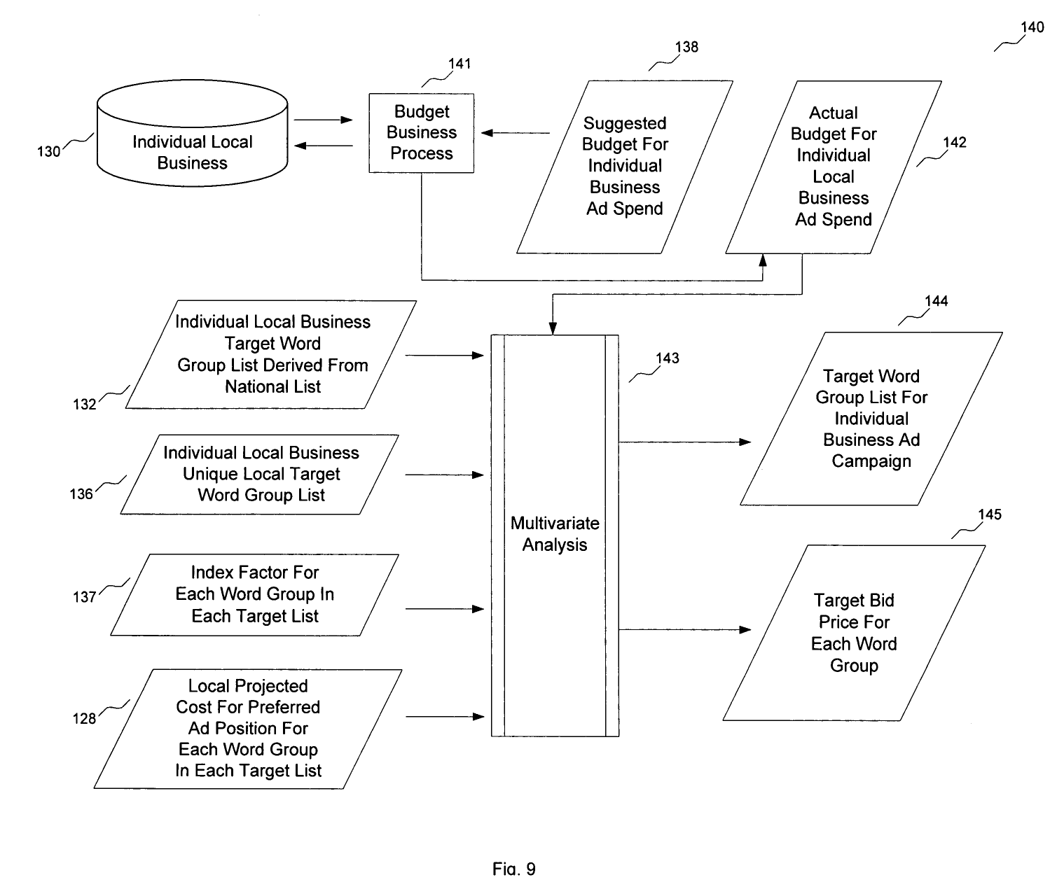

FIG. 9 represents a business process 140 to refine an on line search ad spend budget for an individual local business 130. Using this refined budget, multivariate analysis 143 is applied to find the target word group list 144 and target bid price 145 for each of these individual terms and phrases 132, 136. The suggested ad spend budget derived using the method 135 described in FIG. 8 may or may not exceed the ad spending ability of the individual local business. A budget business process 141 with the individual local business 130 will determine an on line ad spend budget 142 that fits the current spending ability of the individual local business. Using multivariate analysis 143 on the individual local business target word group list derived from national list 132, the individual local business unique local target word group list 136, the index factor for each word group in each target list 137, and the local projected cost for preferred ad position 128 for each word group in each target list derives a list of target terms and phrases 144 and a suggested bid price for preferred ad position 145 for each of these suggested terms and phrases 144 that match the ad spend budget 142 of the individual local business 130. In embodiments, the method derives an optimal set of search terms and phrases for the individual local small business to place paid search bids on that will match the small business budget needs. In many cases, most businesses will not be able to spend up to the recommended spend level for optimum placement for all of the possible search terms and phrases that relate to their specific category of business. In embodiments, a business interview process with the local business determines a budget for the local business. The need exists to determine which search terms and phrases related to the individual business would generate the largest pool of potential profitable customers. In embodiments, the method uses multivariate analysis to derive the list of search terms and phrases while also establishing a suggested bid price where the combination of search terms and phrases coupled with the suggested bid price should closely match the budget determined in the interview process. In embodiments, the interview business process occurs on a daily, weekly, monthly, or other seasonal time frame and can be used to derive a new set of search terms and phrases with their suggested bid price at any time.

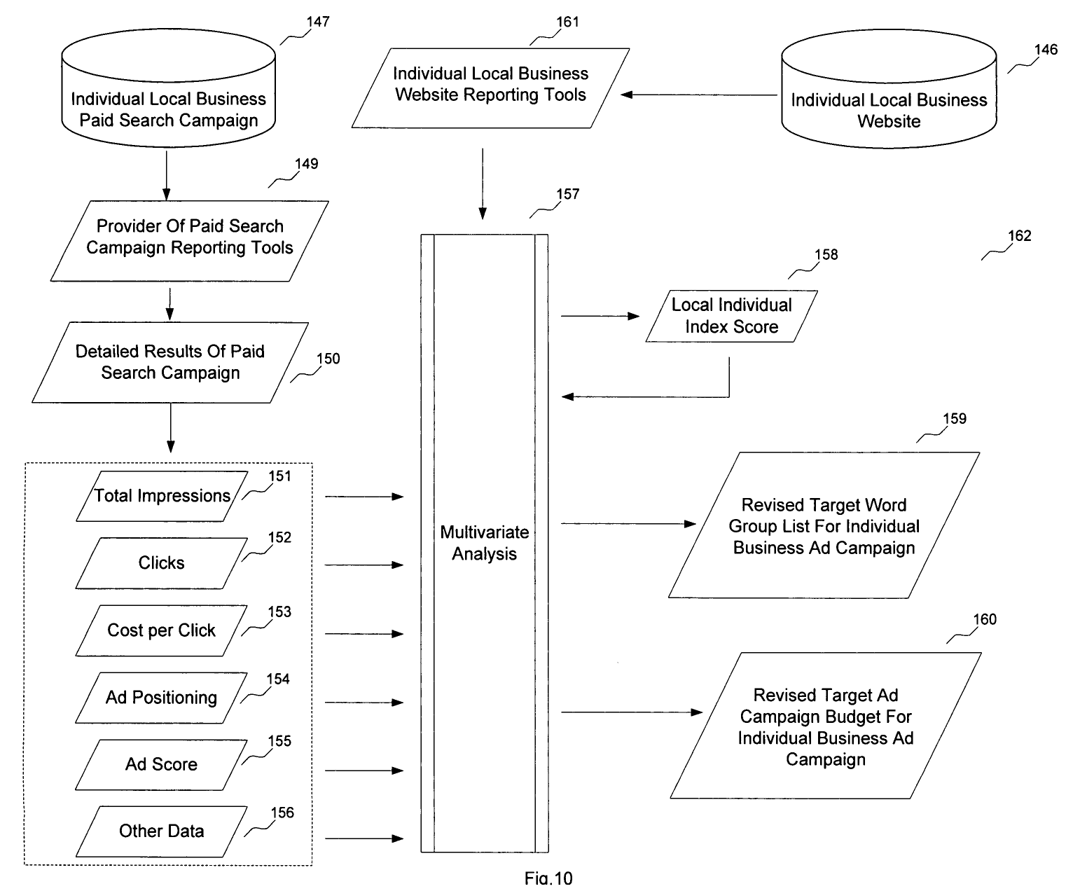

FIG. 10 represents a method 162 to continually refine the target word group list 159 for the individual local business FIG. 8 130 and the target price for preferred ad placement 160 of the target word group list. An individual local business FIG. 8 130 will run a paid search campaign 147 with one or more paid search providers. These paid search providers generate detailed data results 149 related to the success of the paid search campaign of the individual local business. This data may consist of total impressions for each individual search term or phrase 151, total clicks on each individual ad for each individual search term or phrase 152, average cost per ad click 153, positioning of the individual ad 154, a score from the paid search provider on the individual ad 155, and other related data 156. The individual local business will have a website 146 the ad clicks are directed to. The website will have tools 161 embedded in the website to track many details related to clicks to the website including but not limited to, time spent on the web site, pages visited on the web site, geographic location of the user clicking on the ad and more. Both the data from the paid search providers related to the individual local business paid search campaign and the data from the individual local business website are entered into a relational database. Based on this data, multivariate analysis 157 is used to obtain an additional index value known as the local index value 158. This is an individual value for each of the search terms and phrases of the individual local business paid search campaign. Using the additional index value 158 and multivariate analysis 157 a refined suggested ad budget 160 is calculated and in addition a refined list of search terms and phrases 159 suggested for the individual local business. In embodiments, this method uses all of the data available to the individual business to refine the advertising campaign based on multivariate analysis. In embodiments, the method described may or may not run in real time, daily, weekly, monthly or any other cycle. In embodiments, this method may be used to provide the individual local business with recommended paid on line search budgets based upon changing conditions.

In embodiments, the methods of this invention use national business category experts, multivariate analysis, and individual local specific business interviews to derive an optimum on line paid search advertising campaign for a specific local business. In embodiments, the data provided by both the national search engines and the individual local business web site are used with multivariate analysis to refine the on line paid search ad campaign of the individual local business.

What is claimed is:

1. A system for dynamically managing on line advertising bids for key terms and phrases, the system comprising of a multiple phase interview process and a computer having stored instructions which, when used in conjunction as a process performs the steps of:
receiving data to derive a national list of key words and phrases;
receiving and assigning values to the national list of terms and phrases and calculating an index value of said terms and phrases comprising of profit margin, selling price, long term value, and other values;
receiving data comprising of local costs for online advertising of the search terms and phrases;
receiving data comprising of local variables related to the national search terms and phrases as they apply to a local individual business, this data comprising of local search terms and phrases;
calculating a suggested on line advertising budget for any specific individual local business;
receiving data from said specific local business in regards to the specific budget;
calculating a list comprising of the most cost effective search terms and phrases for the individual local business with suggested bids comprising of bid rates for each individual search term or phrase and suggested negative terms to apply to the bids.

2. The system of claim 1 comprising of a multiple phase interview process and a computer having stored instructions which, when used in conjunction as a process performs the steps of:
receiving data from the individual local business website comprising of time spent on site, pages visited, purchases made;
receiving data from the national search engines where the search terms and phrases had bids placed comprising of total impressions, ad position, click through rate, cost per click;
calculating a local index value for each of the individual business search terms and phrases
calculating a refined list of comprising of the most cost effective search terms and phrases for the individual local business with suggested bids comprising of bid rates for each individual search term or phrase and suggested negative terms to apply to the bids.
